(19) United States
(12) Patent Application Publication
(10) Pub. No.: US 2026/0116095 A1
(43) Pub. Date: Apr. 30, 2026

(54) IMAGE FORMING APPARATUS

(71) Applicant: KYOCERA Document Solutions Inc., Osaka (JP)

(72) Inventor: Shunsuke Takada, Osaka (JP)

(21) Appl. No.: 19/363,364

(22) Filed: Oct. 20, 2025

(30) Foreign Application Priority Data
Oct. 24, 2024 (JP) 2024-187121

(51) Int. Cl. B41J 11/00; B41J 11/64; B41J 13/00; B41J 13/08

(52) U.S. Cl. CPC B41J 11/006; B41J 11/0095; B41J 11/64; B41J 13/0018; B41J 13/0036; B41J 13/009; B41J 13/08

(57) ABSTRACT

A sheet conveying device includes a plurality of switching portions each having a plurality of branch paths branching off from a standard conveying path and a plurality of sheet collection portions configured to collect sheets at a later stage of the branch paths. The switching portions can selectively execute a normal conveying process in which each of a plurality of sheets is conveyed along the standard conveying path, and an emergency conveying process in which each of the plurality of sheets is conveyed to each of the sheet collection portions. The control device, when a jam is detected, causes a terminal switching portion, which is located farthest downstream in the sheet conveying direction among upstream switching portions having a path branching from an area downstream of the jam area, to execute the emergency conveying process, and causes the other portions to execute the normal or emergency conveying process.

### INCORPORATION BY REFERENCE

This application is based upon and claims the benefit of priority from the corresponding Japanese Patent Application No. 2024-187121 filed on October 24, 2024, the entire contents of which are incorporated herein by reference.

### BACKGROUND

The present disclosure relates to an image forming apparatus capable of detecting a jam in a sheet conveying path.

An image forming apparatus includes a sheet conveying device and a printing device. The sheet conveying device sequentially conveys a plurality of sheets along a conveying path. The printing device forms an image on each of the sheets at a printing position on the conveying path.

In addition, it is also known that when a jam is detected on the conveying path, the image forming apparatus selectively conveys the sheet that has passed the printing position to either a terminating end portion of a main conveying path or a branch path that branches off from the main conveying path.

### SUMMARY

An image forming apparatus according to one aspect of the present disclosure includes a standard conveying path forming a path for sheets, a sheet feeding device, a sheet conveying device, a printing device, a jam detecting device, and a control device. The sheet feeding device sequentially feeds a plurality of sheets to the standard conveying path. The sheet conveying device conveys each of the plurality of sheets along the standard conveying path. The printing device forms an image on each of the sheets at a printing position on the standard conveying path. The jam detecting device detects jams in each of a plurality of detection areas on the standard conveying path. The control device controls the sheet conveying device. The sheet conveying device includes a plurality of switching portions each having a plurality of branch paths that branch off from a plurality of branch positions on the standard conveying path and a plurality of sheet collection portions that collect sheets at a later stage of the plurality of branch paths. The plurality of switching portions are capable of selectively executing a normal conveying process and an emergency conveying process. The normal conveying process is a process of conveying each of the plurality of sheets along the standard conveying path toward an outlet of the standard conveying path at each of the plurality of branch positions. The emergency conveying process is a process of conveying each of the plurality of sheets from the standard conveying path via each of the plurality of branch paths at each of the plurality of branch positions to each of the plurality of sheet collection portions. The control device, when a jam is detected by the jam detecting device, executes upstream conveying control for one or more upstream switching portions that are part of the plurality of switching portions, and downstream conveying control for one or more downstream switching portions that are another part of the plurality of switching portions. The upstream switching portion has a path branching from an upstream area that is an area upstream in the sheet conveying direction of the standard conveying path from a jam area where the jam has been detected. The downstream switching portion has a path branching off from a downstream area that is an area downstream of the jam area on the standard conveying path in the sheet conveying direction. In the upstream conveying control, the control device causes an upstream terminating end switching portion located farthest downstream in the sheet conveying direction among the upstream switching portions to execute the emergency conveying process, and further causes upstream switching portions other than the upstream terminating end switching portion to execute the normal conveying process or the emergency conveying process. In the downstream conveying control, the control device causes the downstream switching portions to execute the normal conveying process or the emergency conveying process.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a configuration diagram of a sheet feeding unit in an image forming apparatus according to an embodiment.

FIG. 3 is a configuration diagram of a printing unit in an image forming apparatus according to an embodiment.

FIG. 4 is a configuration diagram of a sheet processing unit in the image forming apparatus according to an embodiment.

FIG. 5 is a block diagram showing a configuration of a control device in an image forming apparatus according to an embodiment.

FIG. 6 is a flowchart showing an example of a procedure for jam handling control in an image forming apparatus according to an embodiment.

FIG. 7 is a flowchart showing an example of a procedure of a first modification of upstream conveying control in an image forming apparatus according to an embodiment.

FIG. 8 is a flowchart showing an example of a procedure of a second modification of upstream conveying control in an image forming apparatus according to an embodiment.

FIG. 9 is a flowchart showing an example of a procedure of a first modification of downstream conveying control in an image forming apparatus according to an embodiment.

### DETAILED DESCRIPTION

Hereinafter, embodiments according to the present disclosure will be described with reference to the drawings. Note that the following embodiments are examples of specific implementations of a technique according to the present disclosure and do not limit the technical scope of the present disclosure.

### Configuration of Image Forming Apparatus 10

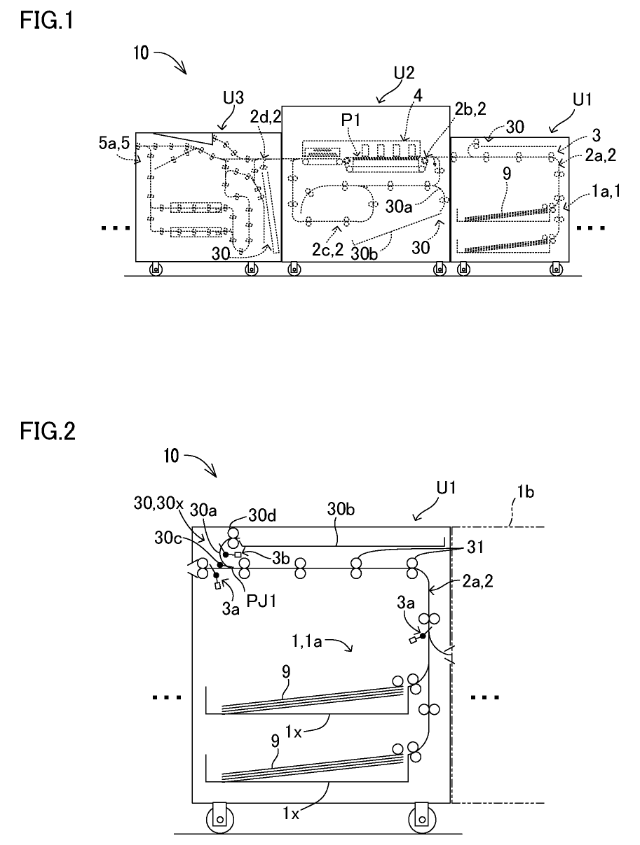

An image forming apparatus 10 of an embodiment includes a sheet feeding device 1, a standard conveying path 2, a sheet conveying device 3, and a printing device 4 (see FIG. 1). The image forming apparatus 10 further includes a sheet processing device 5 that processes a plurality of sheets 9 on which images have been formed.

The sheet feeding device 1 sequentially feeds a plurality of sheets 9 to the standard conveying path 2. The standard conveying path 2 forms a path for a plurality of sheets 9 that are fed sequentially.

The sheet conveying device 3 conveys each of the plurality of sheets 9 along the standard conveying path 2. The printing device 4 forms an image on each sheet 9 at a printing position P1 on the standard conveying path 2.

The image forming apparatus 10 has a configuration in which a sheet feeding unit U1 including the sheet feeding device 1, a printing unit U2 including the printing device 4, and a sheet processing unit U3 including the sheet processing device 5 are connected in series (see FIG. 1). The standard conveying path 2 is arranged across the sheet feeding unit U1, the printing unit U2 and the sheet processing unit U3.

The standard conveying path 2 includes a main conveying path 2b including the printing position P1, a sub-conveying path 2c arranged parallel to the main conveying path 2b, a front conveying path 2a arranged upstream of the main conveying path 2b in a sheet conveying direction, and a rear conveying path 2d arranged downstream of the main conveying path 2b in the sheet conveying direction (see FIG. 1).

The sub-conveying path 2c branches off from the main conveying path 2b at a downstream side in the sheet conveying direction from the printing position P1, and joins the main conveying path 2b at an upstream side in the sheet conveying direction from the printing position P1.

Note that the sub-conveying path 2c is a path along which the sheet 9 is conveyed after passing through the main conveying path 2b. In the present embodiment, the sub-conveying path 2c and the rear conveying path 2d are each an example of a portion of the standard conveying path 2 on the downstream side of the printing position P1 in the sheet conveying direction.

The front conveying path 2a is arranged in the sheet feeding unit U1, the main conveying path 2b and the sub-conveying path 2c are arranged in the printing unit U2, and the rear conveying path 2d is arranged in the sheet processing unit U3 (see FIGS. 1 to 4).

In the present embodiment, the sheet feeding device 1 is a cut sheet feeding device 1a that feeds a plurality of sheets 9 stored in a sheet storing portion 1x one by one to the front conveying path 2a (see FIG. 2). Each of the sheets 9 stored in the sheet storing portion 1x is a cut sheet that has been cut to a standard size in advance.

Note that the sheet feeding unit U1 may include a roll sheet feeding device 1b. The roll sheet feeding device 1b unwinds a roll sheet and cuts the unwound portion of the roll sheet to sequentially produce a plurality of sheets 9 of a specific size. Furthermore, the roll sheet feeding device 1b sequentially feeds the produced plurality of sheets 9 to the front conveying path 2a.

The sheet conveying device 3 conveys each of the plurality of sheets 9 fed to the front conveying path 2a along the front conveying path 2a and the main conveying path 2b. Furthermore, the sheet conveying device 3 conveys some or all of the sheets 9 to be double-sided printed from the main conveying path 2b to the sub-conveying path 2c, and then conveys the sheets 9 again along the main conveying path 2b.

Furthermore, the sheet conveying device 3 conveys each of the plurality of sheets 9 from the main conveying path 2b to the rear conveying path 2d, and then conveys the sheets 9 along the rear conveying path 2d.

The sheet conveying device 3 includes a plurality of sets conveying roller pairs 31, a first belt conveying device 32, a second belt conveying device 33, and a plurality of path switching mechanisms 34, each of which is arranged along the standard conveying path 2 (see FIGS. 2 to 4).

Each of the conveying roller pairs 31 receives power from a motor (not shown) and rotates to convey each of the sheets 9. Part of the plurality of sets of conveying roller pairs 31 convey each of the sheets 9 along the front conveying path 2a, and further convey each of the sheets 9 from the front conveying path 2a to the main conveying path 2b.

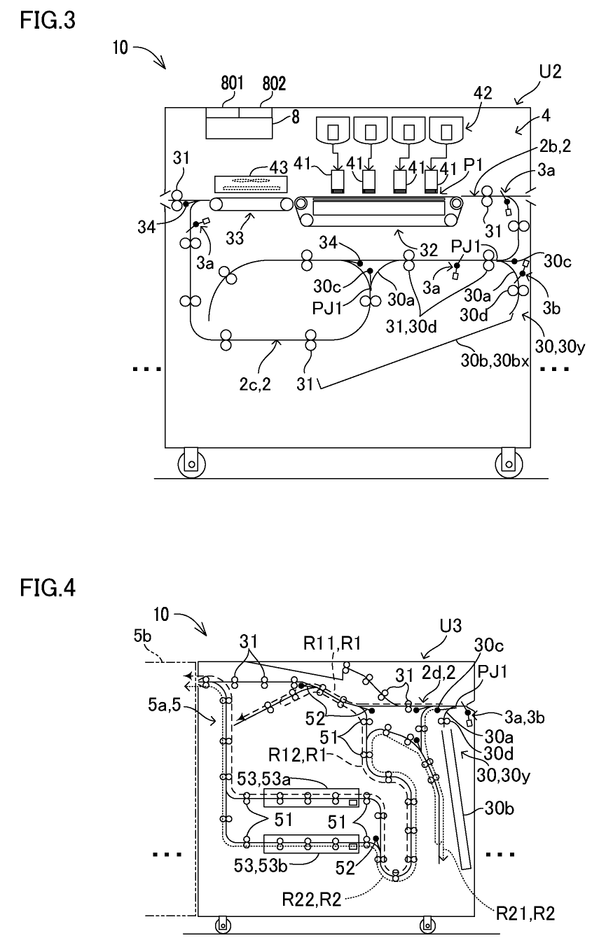

The first belt conveying device 32 takes over conveying of each of the sheets 9 from part of the plurality of sets of conveying roller pairs 31, and further conveys each of the sheets 9 along the main conveying path 2b at the printing position P1 (see FIG. 3).

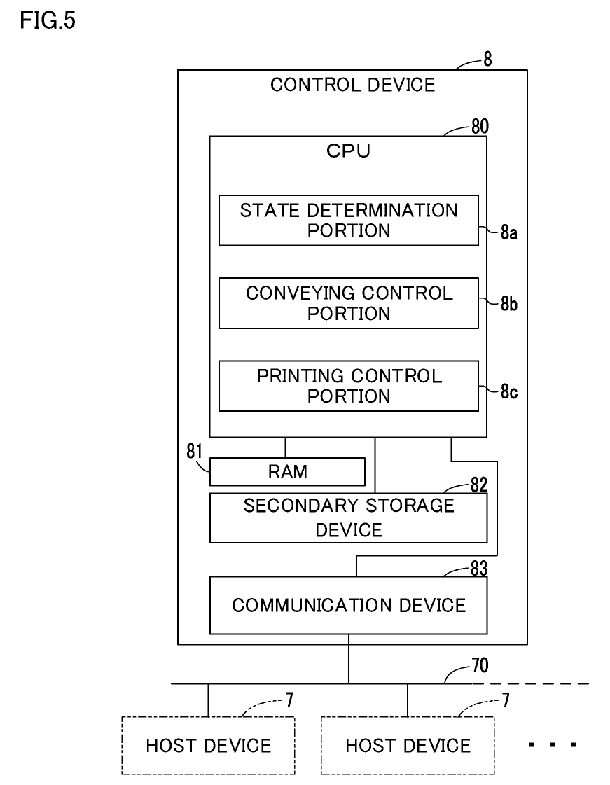

The second belt conveying device 33 takes over the conveying of each of the sheets 9 from the first belt conveying device 32, and further conveys each of the sheets 9 along the main conveying path 2b (see FIG. 3). Another part of the plurality of sets of conveying roller pairs 31 take over conveying of each of the sheets 9 from the second belt conveying device 33, and convey each of the sheets 9 along the rear conveying path 2d (see FIG. 4).

The plurality of path switching mechanisms 34 switch the conveying path of each of the sheets 9 at a plurality of branch portions on the standard conveying path 2. For example, part of the plurality of path switching mechanisms 34 switch the conveying path of part or all of the sheets 9 that have passed through the second belt conveying device 33 from the main conveying path 2b to the sub-conveying path 2c (see FIG. 3).

Furthermore, the sheet conveying device 3 includes a plurality of normal path sheet detecting devices 3a (see FIGS. 2 to 4). The plurality of normal path sheet detecting devices 3a detect each of the sheets 9 conveyed along the standard conveying path 2 at a plurality of detection positions on the standard conveying path 2.

The printing device 4 forms an image on each of the sheets 9 at the printing position P1 on the main conveying path 2b. In the present embodiment, the printing device 4 is an inkjet recording device that forms an image on each of the sheets 9 conveyed by the first belt conveying device 32 by inkjet printing (see FIG. 3).

Therefore, the printing device 4 includes a plurality of inkjet heads 41 that eject ink of different colors onto the sheet 9, and a plurality of ink supply portions 42 that supply ink to the inkjet heads 41 (see FIG. 3).

The printing device 4 further includes a drying device 43 for drying the ink image on each of the sheets 9 conveyed by the second belt conveying device 33 (see FIG. 3).

Note that the printing device 4 may, for example, be a device that forms an image on each of the sheets 9 using another method, such as an electrophotographic method.

The sheet processing device 5 executes sheet processing on a plurality of sheets 9 on which images are formed. In the present embodiment, the sheet processing device 5 is an orientation adjusting device 5a that adjusts the direction of each of the sheets 9 (see FIG. 4).

The orientation adjusting device 5a includes a plurality of adjusting conveying paths R1, R2, a plurality of sets of conveying roller pairs 51, a plurality of path switching mechanisms 52, and a plurality of sheet position correcting devices 53 (see FIG. 4). The plurality of adjusting conveying paths R1, R2 are configured by a part of the rear conveying path 2d and a conveying path branched off from the rear conveying path 2d.

In the example shown in FIG. 4, the plurality of adjusting conveying paths R1, R2 include a first adjusting conveying path R1 and a second adjusting conveying path R2. The plurality of sheet position correcting devices 53 include a first sheet position correcting device 53a arranged on the first adjusting conveying path R1 and a second sheet position correcting device 53b arranged on the second adjusting conveying path R2.

The plurality of sets of conveying roller pairs 51 are driven to rotate by a motor (not shown). The plurality of sets of conveying roller pairs 51 rotate to convey each of the sheets 9 along one of the plurality of adjusting conveying paths R1, R2.

The plurality of path switching mechanisms 52 alternately switch the conveying path of the plurality of sheets 9 between the first adjusting conveying path R1 and the second adjusting conveying path R2.

The first adjusting conveying path R1 includes a first forward conveying path R11 and a first reverse conveying path R12. The second adjusting conveying path R2 includes a second forward conveying path R21 and a second reverse conveying path R22.

The first forward conveying path R11 branches off from the rear conveying path 2d and leads to the first reverse conveying path R12. The first reverse conveying path R12 includes a portion connected to the first forward conveying path R11, and a portion that branches off from the portion connected to the first forward conveying path R11 and joins the rear conveying path 2d.

The second forward conveying path R21 branches off from the rear conveying path 2d and leads to the second reverse conveying path R22. The second reverse conveying path R22 includes a portion connected to the second forward conveying path R21, and a portion that branches off from the portion connected to the second forward conveying path R21 and joins the rear conveying path 2d.

The plurality of sets of conveying roller pairs 51 and the plurality of path switching mechanisms 52 selectively execute one of a first adjusting conveying process and a second adjusting conveying process. The first adjusting conveying process is a process of conveying the sheet 9 to the first forward conveying path R11, inverting the leading and trailing edges of the sheet 9, and conveying the sheet 9 along the first reverse conveying path R12. The second adjusting conveying process is a process of conveying the sheet 9 to the second forward conveying path R21, inverting the leading and trailing edges of the sheet 9, and conveying the sheet 9 along the second reverse conveying path R22.

The first sheet position correcting device 53a corrects a positional deviation of each of the sheets 9 conveyed along the first reverse conveying path R12. The second sheet position correcting device 53b corrects the positional deviation of each of sheets 9 conveyed along the second reverse conveying path R22.

The sheet processing unit U3 may include a post-processing device 5b that processes some or all of the plurality of sheets 9. For example, the post-processing device 5b includes some or all of a hole punching device, a stapling device, and a sheet folding device.

The hole punching device punches punch holes in each of the sheets 9. The stapling device performs a stapling process to bind a plurality of sheets 9 together. The sheet folding device executes a sheet folding process for folding one or more sheets 9.

The image forming apparatus 10 further includes an operation device 801, a display device 802, and a control device 8 (see FIG. 3). In the example shown in FIG. 3, the operation device 801, the display device 802 and the control device 8 are provided in the printing unit U2.

However, the operation device 801, the display device 802, and part or all of the control device 8 may be provided in the sheet feeding unit U1 or the sheet processing unit U3.

The operation device 801 detects an operation by a person. For example, the operation device 801 includes a plurality of operation buttons and a touch panel. The display device 802 is capable of displaying various types of information. For example, the display device 802 is a panel display device such as a liquid crystal display panel.

The control device 8 controls the sheet feeding device 1, the sheet conveying device 3, the printing device 4 and the sheet processing device 5.

As shown in FIG. 5, the control device 8 includes a central processing unit (CPU) 80, a random access memory (RAM) 81, a secondary storage device 82, a communication device 83, and the like.

The CPU 80 executes various types of control and data processing by executing computer programs. The RAM 81 temporarily stores the computer programs executed by the CPU 80 and various types of data.

The secondary storage device 82 is a computer-readable non-volatile storage device. The secondary storage device 82 stores the computer programs executed by the CPU 80 and various types of data. For example, a flash memory or a hard disk drive, or both, may be employed as the secondary storage device 82.

The communication device 83 executes communication with other devices such as a host device 7 through a network 70. The CPU 80 executes communication with other devices via the communication device 83. The host device 7 is an information processing apparatus that requests the image forming apparatus 10 to perform a printing process. The printing process is a process for forming an image on each of the sheets 9.

The CPU 80 includes a plurality of processing modules that are achieved by executing the computer program. The plurality of processing modules include a state determination portion 8a, a conveying control portion 8b, and a printing control portion 8c (see FIG. 5).

The state determination portion 8a determines a state of the image forming apparatus 10 in accordance with detection results of various types of detecting devices such as the normal path sheet detecting devices 3a.

For example, the state determination portion 8a executes a jam detecting process to detect a jam on the standard conveying path 2 according to the operation state of the sheet conveying device 3 and the detection results of each of the normal path sheet detecting devices 3a. The jam is a blockage of a sheet 9.

Here, one of the plurality of sheets 9 that is a target of the jam detecting process is called a target sheet. In addition, of the plurality of normal path sheet detecting devices 3a, the two located at a position where the target sheet passes and a position where the target sheet is scheduled to pass next are referred to as the first target detecting device and the second target detecting device, respectively.

The state determination portion 8a detects a jam when the second target detecting device does not detect the target sheet until a reference conveying time has elapsed since the first target detecting device detected the passage of the target sheet. In this case, the state determination portion 8a detects the jam in an area on the standard conveying path 2 from the position of the first target detecting device to the position of the second target detecting device.

In addition, the state determination portion 8a also detects the jam when the time during which the first target detecting device continuously detects the target sheet exceeds a standard passing time. In this case, the state determination portion 8a detects the jam in an area that includes the position of the first target detecting device on the standard conveying path 2 and that corresponds to the length of the target sheet.

The standard conveying time is set in accordance with the conveying speed of each of the sheets 9 by the sheet conveying device 3 and the path length from the first target detecting device to the second target detecting device. The standard passing time is set in accordance with the conveying speed of each of the sheets 9 by the sheet conveying device 3 and the sheet length of the target sheet.

The plurality of normal path sheet detecting devices 3a and the state determination portion 8a are an example of jam detecting devices that detect a jam in each of the plurality of detection areas on the standard conveying path 2.

The conveying control portion 8b controls the sheet feeding device 1 and the sheet conveying device 3 to control the feeding and conveying of each of the sheets 9. For example, the conveying control portion 8b controls the conveying timing of each of the sheets 9 to the printing position P1 in accordance with the detection result of one of the plurality of normal path sheet detecting devices 3a located before the printing position P1.

The printing control portion 8c causes the printing device 4 to execute the printing process in synchronization with the conveying of each of the sheets 9. Furthermore, the printing control portion 8c controls the power supply to a heater provided in the drying device 43.

When the jam is detected, the sheet 9 may remain in an area on the standard conveying path 2 upstream in the sheet conveying direction from the area where the jam was detected.

The image forming apparatus 10 has a configuration for eliminating the time and effort needed to remove the sheets 9 present in the areas upstream and downstream in the sheet conveying direction from the area where the jam was detected. The configuration will be explained below.

The sheet conveying device 3 includes a plurality of switching portions 30 (see FIGS. 2 and 3). The plurality of switching portions 30 include a plurality of branch paths 30a, a plurality of sheet collection portions 30b, a plurality of path switching mechanisms 30c, and a plurality of sets of collection roller pairs 30d (see FIGS. 2 to 4).

The plurality of sets of branch paths 30a are conveying paths that branch off from a plurality of branch positions PJ1 on the standard conveying path 2. The plurality of sheet collection portions 30b are portions that collect the sheets 9 at the rear of the plurality of conveying paths 30a, respectively. For example, each of the sheet collection portions 30b is a collection tray that receives the sheets 9 or a collection box that stores the sheets 9.

Each of the sheet collection portions 30b is arranged at a position that can be accessed directly from the outside of the image forming apparatus 10 or by opening a cover formed on an exterior portion of the image forming apparatus 10. A user can access each of the sheet collection portions 30b and remove the sheets 9 from each of the sheet collection portions 30b.

The plurality of path switching mechanisms 30c are switchable between a normal state in which the plurality of sheets 9 are guided along the standard conveying path 2 at each of the plurality of branch positions PJ1 and an emergency state in which the plurality of sheets 9 are guided from the standard conveying path 2 to each of the plurality of branch paths 30a.

The plurality of sets of collection roller pairs 30d are driven and rotated by a motor (not shown). The plurality of sets of collection roller pairs 30d convey the sheets 9 guided to the plurality of branch paths 30a to the plurality of sheet collection portions 30b, respectively. Thus, the sheets 9 are collected in the respective sheet collecting portions 30b.

Each of the switching portions 30 can selectively perform a normal conveying process and an emergency conveying process at each of the branch positions PJ1.

The normal conveying process is a process of conveying each of the sheets 9 at each of the branch positions PJ1 along the standard conveying path 2 toward the outlet of the standard conveying path 2. Each of the switching portions 30 executes the normal conveying process by maintaining each of the path switching mechanisms 30c in the normal state.

The emergency conveying process is a process of conveying each of the sheets 9 from the standard conveying path 2 to each of the sheet collection portions 30b via each of the branch paths 30a at each of the branch positions PJ1. Each of the switching portions 30 switches each of the path switching mechanisms 30c to the emergency state, thereby executing the emergency conveying process.

In the example shown in FIG. 3, the plurality of sheet collection portions 30b include a shared collection portion 30bx. The shared collection portion 30bx is one of the plurality of switching portions 30, and has two branch paths 30a branching at two branch positions PJ1 and a shared collection portion 30bx corresponding to the two branch paths 30a.

In the example shown in FIG. 3, one of the two branch paths 30a corresponds to one of the two branch positions PJ1. In addition, the two branch paths 30a branching at the two branch positions PJ1 and parts of the sub-conveying path 2c constitute the branch paths 30a corresponding to the two branch positions PJ1.

The plurality of switching portions 30 include one or more pre-printing switching portions 30x and one or more post-printing switching portions 30y (see FIGS. 2 to 4).

The pre-printing switching portion 30x has a path branching off from a position upstream of the printing position P1 in the sheet conveying direction (see FIG. 2). In the present embodiment, the pre-printing switching portion 30x having a path branched from the front conveying path 2a is arranged in the sheet feeding unit U1.

The post-printing switching portion 30y has a path branching off from a position downstream in the sheet conveying direction from the printing position P1 (see FIGS. 3 and 4). In the present embodiment, three post-printing switching portions 30y are arranged in the printing unit U2 and the sheet processing unit U3.

One of two post-printing switching portions 30y has a path extending from one of two branch positions PJ1 on the sub-conveying path 2c to the shared collection portion 30bx (see FIG. 3). The other of the two post-printing switching portions 30y has a path branching off from one of the plurality of branch positions PJ1 on the rear conveying path 2d (see FIG. 4).

The image forming apparatus 10 further includes a plurality of branch path sheet detecting devices 3b that detect the sheets 9 conveyed along each of the plurality of branch paths 30a (see FIGS. 2 to 4). The sheets 9 detected by each of the branch path sheet detecting devices 3b are the sheets 9 to be collected in each of the sheet collection portions 30b.

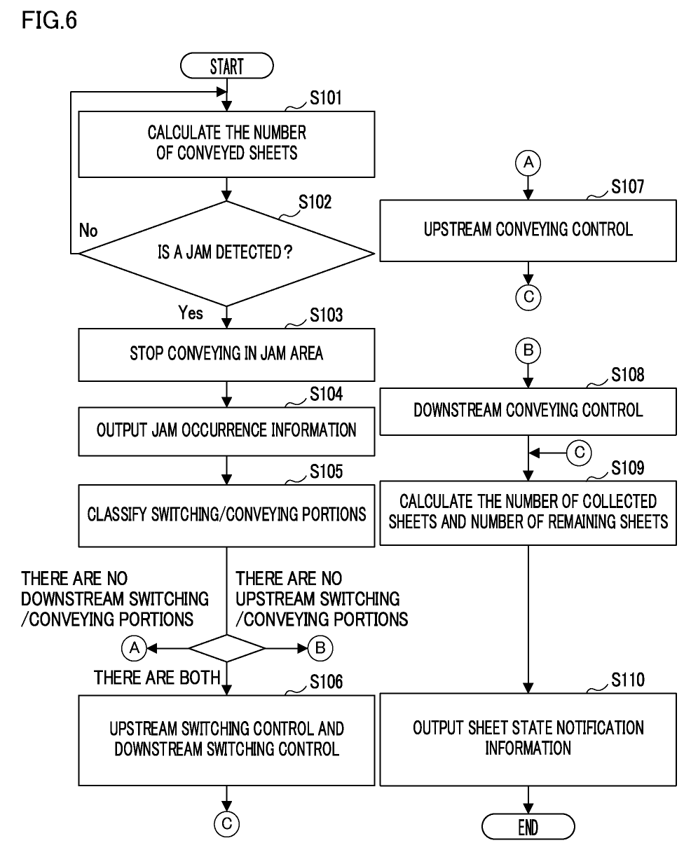

The state determination portion 8a executes the jam detecting process when the sheet conveying device 3 executes a continuous conveying process in which the sheet conveying device 3 sequentially conveys a plurality of sheets 9 along the standard conveying path 2. In addition, the conveying control portion 8b executes jam handling control when the sheet conveying device 3 is executing the continuous conveying process (see FIG. 6).

### Jam Handling Control

An example of a procedure for the jam handling control will be described below with reference to the flowchart shown in FIG. 6.

In the following description, S101, S102, and so on represent identification codes of a plurality of steps in the jam handling control. In the jam handling control, first, the process of step S101 is executed.

### Step S101

In step S101, the conveying control portion 8b calculates the number of conveyed sheets according to detection results by the plurality of normal path sheet detecting devices 3a. The number of conveyed sheets is the number of a plurality of sheets 9 present in the image forming apparatus 10.

The conveying control portion 8b executes the process of step S102 in addition to the process of step S101.

### Step S102

In step S102, the conveying control portion 8b selects the next process depending on the result of the jam detecting process by the state determination portion 8a.

In a case in which the jam is not detected, the conveying control portion 8b repeats the processes of steps S101 and S102. On the other hand, in a case in which the jam is detected, the conveying control portion 8b executes the process of step S103.

The processes of steps S103 to S110 shown below are processes that are executed when the jam is detected by the jam detecting process by the state determination portion 8a.

### Step S103

In step S103, the conveying control portion 8b causes the sheet conveying device 3 to stop conveying the sheet 9 in the jam area. The jam area is an area on the standard conveying path 2 where the jam was detected.

The sheet conveying device 3 includes a conveying gear mechanism that transmits the rotation of one or more motors to a plurality of sets of conveying roller pairs 31, a first belt conveying device 32, and a second belt conveying device 33, and a plurality of clutches provided in the conveying gear mechanism (not shown).

Each of the clutches blocks transmission of rotation from the conveying gear mechanism to a part of the plurality of sets of conveying roller pairs 31, the first belt conveying device 32 and the second belt conveying device 33. In step S103, the conveying control portion 8b operates a part of the plurality of clutches corresponding to the jam area.

The conveying control portion 8b executes the process of step S104 following the process of step S103.

### Step S104

In step S104, the conveying control portion 8b outputs jam occurrence information via one or both of the display device 802 and the communication device 83. For example, the conveying control portion 8b outputs the jam occurrence information to a manager's host device 7 via the communication device 83.

The jam occurrence information includes information notifying that the jam has been detected and information indicating the jam area. The display device 802 and the communication device 83 are each an example of an information output device capable of outputting information.

The conveying control portion 8b executes the process of step S105 following the process of step S104.

### Step S105

In step S105, the conveying control portion 8b executes a process of classifying the plurality of switching portions 30 into upstream switching portions, downstream switching portions, and intermediate switching portions.

In the following description, an area on an upstream side of the jam area in the sheet conveying direction on the standard conveying path 2 will be referred to as an upstream area. Similarly, an area downstream of the jam area in the sheet conveying direction on the standard conveying path 2 is referred to as a downstream area.

The upstream switching portion has a path branching off from the upstream area of the standard conveying path 2. The downstream switching portion has a path branching off from the downstream area of the standard conveying path 2. The intermediate switching portion has a path branching off from the jam area of the standard conveying path 2. The branch path of each of the upstream switching portion, the downstream switching portion, and the intermediate switching portion is one of a plurality of branch paths 30a.

The conveying control portion 8b executes the process of step S106 when the plurality of switching portions 30 include the upstream switching portions and the downstream switching portions.

In addition, the conveying control portion 8b executes the process of step S107 when the plurality of switching portions 30 include one or more of the upstream switching portions and do not include the downstream switching portions.

Moreover, the conveying control portion 8b executes the process of step S108 when the plurality of switching portions 30 do not include the upstream switching portions but include one or more of the downstream switching portions.

### Step S106

In step S106, the conveying control portion 8b executes upstream conveying control for one or more of the upstream switching portions and downstream conveying control for one or more of the downstream switching portions.

A standard example of the upstream conveying control and the downstream conveying control will be described below.

In the upstream conveying control according to the standard example, the conveying control portion 8b causes all of the one or more upstream switching portions to execute the emergency conveying process. Thus, one or more sheets 9 present in the upstream area are conveyed to one of the plurality of sheet collection portions 30b via one of the plurality of branch paths 30a that branch off from the downstream area immediately downstream in the sheet conveying direction relative to the sheet 9.

Here, one of the one or more upstream switching portions located farthest downstream in the sheet conveying direction is referred to as an upstream terminating end switching portion. In the standard example, in a case in which there are a plurality of upstream switching portions, the conveying control portion 8b causes the upstream terminating end switching portion and portions other than the upstream terminating end switching portion among the plurality of upstream switching portions to execute the emergency conveying process.

On the other hand, in the downstream conveying control according to the standard example, the conveying control portion 8b causes all of the one or more downstream switching portions to execute the emergency conveying process. Thus, one or more sheets 9 present in the downstream area are conveyed to one of the plurality of sheet collection portions 30b via one of the plurality of branch paths 30a that branches off from the area immediately downstream in the sheet conveying direction relative to the sheet 9.

The conveying control portion 8b executes the process of step S109 in conjunction with the process of step S106.

### Step S107

In step S107, the conveying control portion 8b executes the upstream conveying control for one or more of the upstream switching portions. For example, the conveying control portion 8b executes the upstream conveying control according to the standard example.

The conveying control portion 8b executes the process of step S109 in conjunction with the process of step S107.

### Step S108

In step S108, the conveying control portion 8b executes the downstream conveying control for one or more of the downstream switching portions. For example, the conveying control portion 8b executes the downstream conveying control according to the standard example.

The conveying control portion 8b executes the process of step S109 in conjunction with the process of step S108.

Note that the conveying control portion 8b continues one of the processes S106 to S108 for a predetermined time and then ends the process.

### Step S109

In step S109, the conveying control portion 8b calculates the number of collected sheets in each of the plurality of sheet collection portions 30b. The conveying control portion 8b calculates the number of collected sheets in accordance with the detection results by the plurality of branch path sheet detecting devices 3b when one or both of the upstream conveying control and the downstream conveying control are being executed.

In step S109, the conveying control portion 8b calculates the number of remaining sheets based on the number of conveyed sheets calculated in step S101 and the number of collected sheets. The number of remaining sheets is the number of sheets 9 remaining on the standard conveying path 2 after one or both of the upstream conveying control and the downstream conveying control are executed.

Usually, the number of remaining sheets is the number of sheets 9 that have jammed on the standard conveying path 2 due to the jam. In addition, in a case in which part of the sheets 9 become jammed while being conveyed by the upstream conveying control or the downstream conveying control, the number of the jammed sheets 9 is also reflected in the number of remaining sheets.

The conveying control portion 8b executes the process of step S110 following the process of step S109.

### Step S110

In step S110, the conveying control portion 8b outputs sheet state notification information via one or both of the display device 802 and the communication device 83. The sheet state notification information includes information on the number of collected sheets and information on the number of remaining sheets.

After executing the process of step S110, the conveying control portion 8b ends the jam handling control.

In the image forming apparatus 10, when the jam is detected, one or more sheets 9 present on the standard conveying path 2 are discharged from the standard conveying path 2.

That is, one or more sheets 9 present on the standard conveying path 2 are collected in one of the plurality sheet collection portions 30b by one or both of the upstream conveying control and the downstream conveying control, or are discharged from the outlet of the standard conveying path 2.

By employing the image forming apparatus 10, effort necessary for removing the sheets 9 present in the upstream area and the downstream area is eliminated.

In addition, in a case in which the standard example of the upstream conveying control is adopted, one or more sheets 9 present in the upstream area of the standard conveying path 2 are conveyed to one of the plurality of sheet collection portions 30b that are located on a shortest path downstream in the sheet conveying direction. Thus, jamming of the sheets 9 conveyed by the upstream conveying control is less likely to occur.

Similarly, in a case in which the standard example of the downstream conveying control is adopted, one or more sheets 9 present in the downstream area of the standard conveying path 2 are conveyed to one of the plurality of sheet collection portions 30b that are located on the shortest path downstream in the sheet conveying direction. Thus, jamming of the sheets 9 conveyed by the downstream conveying control is less likely to occur.

### First Modification of Upstream Conveying Control

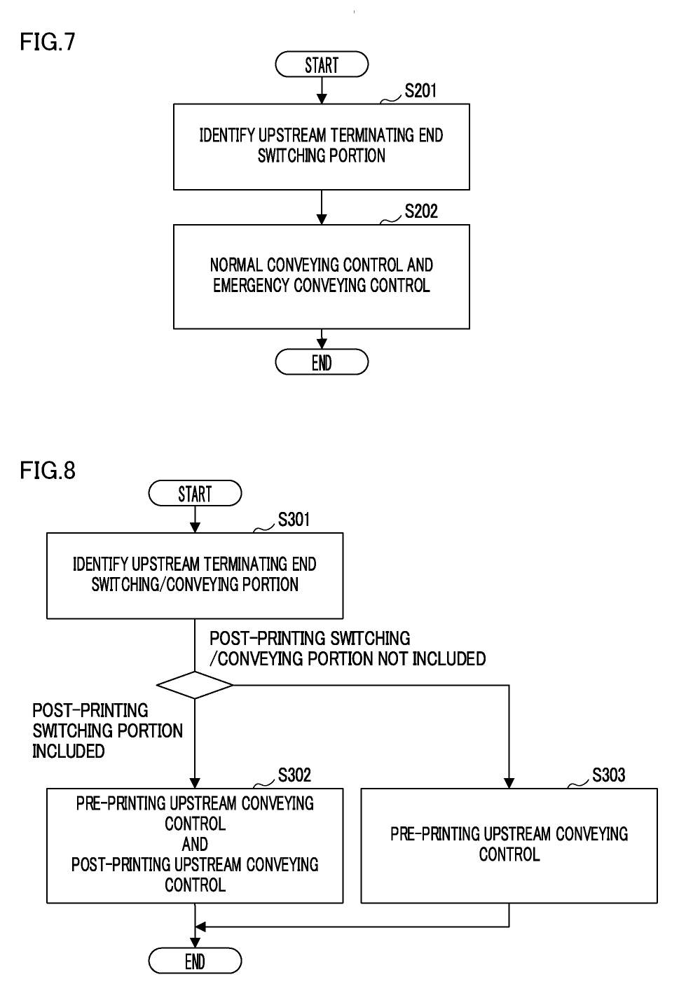

Next, a procedure of a first modification of the upstream conveying control will be described with reference to the flowchart shown in FIG. 7. The process of this modification is executed in step S106 or step S107 in the jam handling control.

In the following description, S201 and S202 represent the identification symbols of two steps in the first modification of the upstream conveying control. In the first modification of the upstream conveying control, the process of step S201 is first executed.

### Step S201

In step S201, the conveying control portion 8b identifies the upstream terminating end switching portion, which is one of the one or more upstream switching portions.

The conveying control portion 8b executes the process of step S202 following the process of step S201.

### Step S202

In step S202, the conveying control portion 8b causes the upstream switching portions other than the upstream terminating end switching portion to execute the normal conveying process, and causes the upstream terminating end switching portion to execute the emergency conveying process.

After executing the process of step S202, the conveying control portion 8b ends the upstream conveying control.

When this modification is adopted and the jam is detected, all of the one or more sheets 9 present in the upstream area of the standard conveying path 2 are conveyed to one of the plurality of sheet collection portions 30b that are included in the upstream terminating end switching portion.

That is, all of the one or more sheets 9 discharged from the upstream area of the standard conveying path 2 by the upstream conveying control are collected together in one place. Thus, the effort needed to remove one or more sheets 9 discharged from the upstream area of the standard conveying path 2 from the image forming apparatus 10 is eliminated.

### Second Modification of Upstream Conveying Control

Next, a procedure of a second modification of the upstream conveying control will be described with reference to the flowchart shown in FIG. 8. The process of this modification is executed in step S106 or step S107 in the jam handling control.

In the following description, S301 to S303 represent identification codes of three steps in the second modification of the upstream conveying control. In the second modification of the upstream conveying control, first, the process of step S301 is executed.

### Step S301

In step S301, the conveying control portion 8b identifies the upstream terminating end switching portion, which is one of the one or more upstream switching portions.

Furthermore, the conveying control portion 8b selects the next process depending on whether or not the upstream switching portion includes the post-printing switching portion 30y.

In a case in which the upstream terminating end switching portion includes a path that branches off on an upstream side of the printing position P1 in the sheet conveying direction, the upstream switching portions do not include the post-printing switching portion 30y.

On the other hand, in a case in which the upstream terminating end switching portion includes a path that branches off downstream in the sheet conveying direction from the printing position P1, the upstream switching portions include the post-printing switching portion 30y.

The conveying control portion 8b executes the process of step S302 in a case in which the upstream switching portions include the post-printing switching portion 30y. On the other hand, the conveying control portion 8b executes the process of step S303 in a case in which the upstream switching portions do not include the post-printing switching portion 30y.

Note that the upstream switching portions including the post-printing switching portion 30y means that the upstream switching portions include the pre-printing switching portion 30x and the post-printing switching portion 30y. On the other hand, the fact that the upstream switching portions do not include the post-printing switching portion 30y means that the upstream switching portions include only the pre-printing switching portion 30x.

### Step S302

In step S302, the conveying control portion 8b executes pre-printing upstream conveying control for the pre-printing switching portion 30x included in the upstream switching portions, and executes post-printing upstream conveying control for the post-printing switching portion 30y included in the upstream switching portions.

In the pre-printing upstream conveying control, the conveying control portion 8b causes the pre-printing switching portion 30x included in the upstream switching portions to execute the emergency transport process. Thus, one or more sheets 9 present on the front conveying path 2a are collected in the sheet collection portion 30b of the pre-printing switching portion 30x without being conveyed to the printing position P1.

By collecting one or more sheets 9 present on the front conveying path 2a in the sheet collecting portion 30b of the pre-printing switching portion 30x, the possibility that the sheets 9 will be soiled with developing agent is reduced. In this embodiment, the developing agent is ink.

On the other hand, in the post-printing upstream conveying control, the conveying control portion 8b causes the post-printing switching portion 30y included in the upstream switching portions to execute the normal conveying process other than the upstream terminal end switching unit, and causes the upstream terminating end switching portion to execute the emergency conveying process.

After executing the process of step S302, the conveying control portion 8b ends the upstream conveying control.

### Step S303

In step S303, the conveying control portion 8b executes the pre-printing upstream conveying control for the pre-printing switching portion 30x included in the upstream switching portions.

After executing the process of step S303, the conveying control portion 8b ends the upstream conveying control.

### First Modification of Downstream Conveying Control

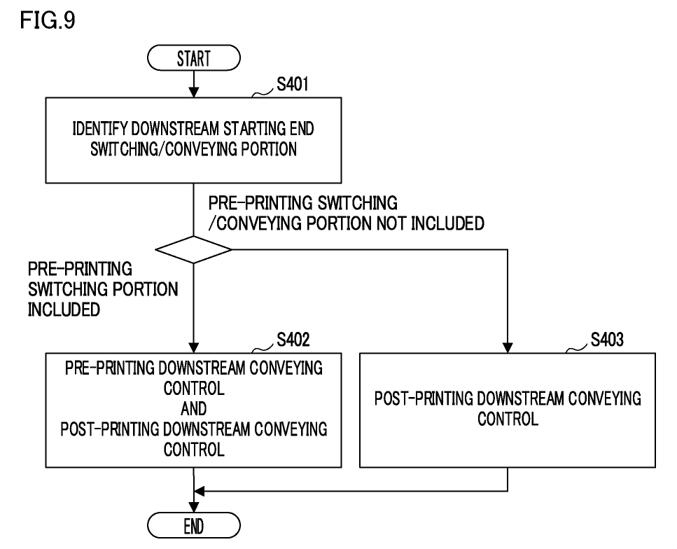

Next, a procedure of a first modification of the downstream conveying control will be described with reference to the flowchart shown in FIG. 9. The process of the present modification is executed in step S106 or step S108 in the jam handling control.

In the following description, S401 to S403 represent identification codes of three steps in the first modification of the downstream conveying control. In the first modification of the downstream conveying control, first, the process of step S401 is executed.

### Step S401

In step S401, the conveying control portion 8b identifies a downstream starting end switching portion, which is one of the one or more downstream switching portions.

The downstream starting end switching portion is one of the one or more downstream switching portions that are located farthest upstream in the sheet conveying direction.

Furthermore, the conveying control portion 8b selects the next process depending on whether or not the downstream switching portions include the pre-printing switching portion 30x.

In a case in which the downstream starting end switching portion includes a path that branches off on the upstream side of the printing position P1 in the sheet conveying direction, the downstream switching portions includes the pre-printing switching portion 30x.

On the other hand, in a case in which the downstream starting end switching portion includes a path that branches off downstream of the printing position P1 in the sheet conveying direction, the downstream switching portions do not include the pre-printing switching portion 30x.

The conveying control portion 8b executes the process of step S402 in a case in which the downstream switching portions include the pre-printing switching portion 30x. On the other hand, the conveying control portion 8b executes the process of step S403 when the downstream switching portions do not include the pre-printing switching portion 30x.

Note that the downstream switching portions including the pre-printing switching portion 30x means that the downstream switching portions include the pre-printing switching portion 30x and the post-printing switching portion 30y. On the other hand, the fact that the downstream switching portions do not include the pre-printing switching portion 30x means that the downstream switching portions include only the post-printing switching portion 30y.

### Step S402

In step S402, the conveying control portion 8b executes pre-printing downstream conveying control for the pre-printing switching portion 30x included in the downstream switching portions, and executes post-printing downstream conveying control for the post-printing switching portion 30y included in the downstream switching portions.

In the pre-printing downstream conveying control, the conveying control portion 8b causes the pre-printing switching portion 30x included in the downstream switching portions to execute the emergency conveying process. Thus, one or more sheets 9 present on the front conveying path 2a are collected in the sheet collection portion 30b of the pre-printing switching portion 30x without being conveyed to the printing position P1.

By collecting one or more sheets 9 present on the front conveying path 2a in the sheet collection portion 30b of the pre-printing switching portion 30x, the possibility that the sheets 9 will be soiled with the developing agent is reduced.

On the other hand, in the post-printing downstream conveying control, the conveying control portion 8b causes the post-printing switching portion 30y included in the downstream switching portions to execute the normal conveying process.

After executing the process of step S402, the conveying control portion 8b ends the upstream conveying control.

### Step S403

In step S403, the conveying control portion 8b executes the post-printing downstream conveying control for the post-printing switching portion 30y included in the downstream switching portions.

After executing the process of step S403, the conveying control portion 8b ends the downstream conveying control.

### Second Modification of Downstream Conveying Control

Next, a procedure of a second modification of the downstream conveying control will be described. The process of the present modification is executed in step S106 or step S108 in the jam handling control.

In the downstream conveying control according to the second modification, the conveying control portion 8b causes all of the downstream switching portions to execute the normal conveying process. When the present modification is adopted, one or more sheets 9 present in the downstream area of the standard conveying path 2 are collectively discharged to one location from the outlet of the standard conveying path 2.

### Supplementary Notes

An outline of the disclosure extracted from the above-described embodiments will be added below. Note that the configurations and processing functions described in the following supplementary notes can be selected and combined as desired.

### Supplementary Note 1

An image forming apparatus, including:

a standard conveying path configured to form a path for sheets;

a sheet feeding device configured to sequentially feed a plurality of sheets to the standard conveying path;

a sheet conveying device configured to convey each of the plurality of sheets along the standard conveying path;

a printing device configured to form an image on each of the plurality of sheets at a printing position on the standard conveying path;

a jam detecting device configured to detect a jam in each of a plurality of detection areas on the standard conveying path; and

a control device configured to control the sheet conveying device; wherein

the sheet conveying device includes a plurality of switching portions each having a plurality of branch paths configured to branch off from a plurality of branch positions on the standard conveying path and a plurality of sheet collection portions configured to collect sheets at a later stage of the plurality of branch paths;

the plurality of switching portions are capable of selectively executing:

a normal conveying process of conveying each of the plurality of sheets along the standard conveying path toward an outlet of the standard conveying path at each of the plurality of branch positions; and

an emergency conveying process for conveying each of the plurality of sheets from the standard conveying path to each of the plurality of sheet collection portions via each of the plurality of branch paths at each of the plurality of branch positions;

the control device, when a jam is detected by the jam detecting device, executes upstream conveying control for one or more upstream switching portions that are part of the plurality of switching portions, and downstream conveying control for one or more downstream switching portions that are another part of the plurality of switching portions;

the upstream switching portion has a path branching from an upstream area that is an area upstream in the sheet conveying direction of the standard conveying path from a jam area where the jam has been detected;

the downstream switching portion has a path branching off from a downstream area that is an area downstream of the jam area on the standard conveying path in the sheet conveying direction;

in the upstream conveying control, the control device causes an upstream terminating end switching portion located at a farthest downstream side in the sheet conveying direction among the upstream switching portions to execute the emergency conveying process, and further causes upstream switching portions other than the upstream terminating end switching portion to execute the normal conveying process or the emergency conveying process; and

in the downstream conveying control, the control device causes the downstream switching portions to execute the normal conveying process or the emergency conveying process.

### Supplementary Note 2

The image forming apparatus according to Supplementary Note 1, wherein

the plurality of switching portions include:

one or more pre-printing switching portions each having a path branching from a position upstream of the printing position in the sheet conveying direction; and

one or more post-printing switching portions each having a path branching off from a position downstream of the printing position in the sheet conveying direction.

### Supplementary Note 3

The image forming apparatus according to Supplementary Note 2, wherein

in a case in which the upstream switching portions include the pre-printing switching portion and the post-printing switching portion, the control device causes the pre-printing switching portion included in the upstream switching portions to execute the emergency conveying process.

### Supplementary Note 4

The image forming apparatus according to Supplementary Note 2 or 3, wherein

in a case in which the downstream switching portions include the pre-printing switching portion and the post-printing switching portion, the control device causes the pre-printing switching portion included in the downstream switching portions to execute the emergency conveying process.

### Supplementary Note 5

The image forming apparatus according to any one of Supplementary Notes 1 to 4, including:

a branch path sheet detecting device configured to detect sheets conveyed along each of the plurality of branch paths; and

an information output device configured to be capable of outputting information; wherein

the control device calculates a number of collected sheets in each of the plurality of sheet collection portions based on detection results by the branch path sheet detecting devices when the upstream conveying control and the downstream conveying control are executed, and outputs notification information including information representing the number of collected sheets to the information output device.

### Supplementary Note 6

The image forming apparatus according to Supplementary Note 5, including

a normal path sheet detecting device configured to detect a sheet conveyed along the standard conveying path; wherein

the control device calculates a number of remaining sheets on the standard conveying path after the upstream conveying control and the downstream conveying control are executed based on detection results by the normal path sheet detecting device and a number of collected sheets, and outputs the notification information including information representing the number of remaining sheets to the information output device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a standard conveying path configured to form a path for sheets;
a sheet feeding device configured to sequentially feed a plurality of sheets to the standard conveying path;
a sheet conveying device configured to convey each of the plurality of sheets along the standard conveying path;
a printing device configured to form an image on each of the plurality of sheets at a printing position on the standard conveying path;
a jam detecting device configured to detect a jam in each of a plurality of detection areas on the standard conveying path; and
a control device configured to control the sheet conveying device; wherein
the sheet conveying device comprises a plurality of switching portions each having a plurality of branch paths configured to branch off from a plurality of branch positions on the standard conveying path and a plurality of sheet collection portions(30b) configured to collect sheets at a later stage of the plurality of branch paths (30a);
the plurality of switching portions are capable of selectively executing:
a normal conveying process of conveying each of the plurality of sheets along the standard conveying path toward an outlet of the standard conveying path at each of the plurality of branch positions; and
an emergency conveying process of conveying each of the plurality of sheets from the standard conveying path to each of the plurality of sheet collection portions via each of the plurality of branch paths at each of the plurality of branch positions;
the control device, when a jam is detected by the jam detecting device, executes upstream conveying control for one or more upstream switching portions that are part of the plurality of switching portions, and downstream conveying control for one or more downstream switching portions that are another part of the plurality of switching portions;
the upstream switching portion has a path branching from an upstream area that is an area upstream in the sheet conveying direction of the standard conveying path from a jam area where the jam has been detected;
the downstream switching portion has a path branching off from a downstream area that is an area downstream of the jam area on the standard conveying path in the sheet conveying direction;
in the upstream conveying control, the control device causes an upstream terminating end switching portion located at a farthest downstream side in the sheet conveying direction among the upstream switching portions to execute the emergency conveying process, and further causes upstream switching portions other than the upstream terminating end switching portion to execute the normal conveying process or the emergency conveying process; and
in the downstream conveying control, the control device causes the downstream switching portions to execute the normal conveying process or the emergency conveying process.

2. The image forming apparatus according to claim 1, wherein
the plurality of switching portions include:
one or more pre-printing switching portions each having a path branching from a position upstream of the printing position in the sheet conveying direction; and
one or more post-printing switching portions each having a path branching off from a position downstream of the printing position in the sheet conveying direction.

3. The image forming apparatus according to claim 2, wherein
in a case in which the upstream switching portions include the pre-printing switching portion and the post-printing switching portion, the control device causes the pre-printing switching portion included in the upstream switching portions to execute the emergency conveying process.

4. The image forming apparatus according to claim 2, wherein
in a case in which the downstream switching portions include the pre-printing switching portion and the post-printing switching portion, the control device causes the pre-printing switching portion included in the downstream switching portions to execute the emergency conveying process.

5. The image forming apparatus according to claim 1, comprising:
a branch path sheet detecting device configured to detect sheets conveyed along each of the plurality of branch paths; and
an information output device configured to be capable of outputting information; wherein
the control device calculates a number of collected sheets in each of the plurality of sheet collection portions based on detection results by the branch path sheet detecting devices when the upstream conveying control and the downstream conveying control are executed, and outputs notification information including information representing the number of collected sheets to the information output device.

6. The image forming apparatus according to claim 5, comprising
a normal path sheet detecting device configured to detect a sheet conveyed along the standard conveying path; wherein
the control device calculates a number of remaining sheets on the standard conveying path after the upstream conveying control and the downstream conveying control are executed based on detection results by the normal path sheet detecting device and a number of collected sheets, and outputs the notification information including information representing the number of remaining sheets to the information output device.
